(19) United States
(12) Patent Application Publication
(10) Pub. No.: US 2005/0209744 A1
(43) Pub. Date: Sep. 22, 2005

(54) Commercial vehicle operation using dynamic rebranding

(76) Inventors: Thomas S. Ihbe, St. Paul, MN (US); Larry S. Hebert, Hudson, WI (US); Michael P. Daniels, Inver Grove Heights, MN (US); Timothy M. Dietz, Mendota Heights, MN (US); Daniel R. Fronek, Woodbury, MN (US); Mark D. Weigel, Hugo, MN (US)

Correspondence Address: 3M INNOVATIVE PROPERTIES COMPANY, PO BOX 33427, ST. PAUL, MN, 55133-3427, US

(21) Appl. No.: 11/082,396

(22) Filed: Mar. 17, 2005

Related U.S. Application Data
(60) Provisional application No. 60/554,404, filed on Mar. 17, 2004.

(51) Int. Cl. G06F 17/00

(52) U.S. Cl. 701/3

(57) ABSTRACT

The disclosure describes a system and method for commercial vehicle operation using reconfigurable brand image technology to support dynamic rebranding. A vehicle may initially carry a first brand image, such as a company name, logo, or the like, associated with a first operator. The brand image is then reconfigured so that the vehicle carries a second brand image, associated with a second operator. Rebranding supports shared use of a vehicle by multiple operators, while permitting individual operators to preserve their brands. A networked system enables rebranding clients to access databases storing scheduling, branding, and accounting information. Rebranding clients access a scheduling database to determine when a particular vehicle is scheduled for operation, and whether an operator or service change will take place. The branding database permits the rebranding client to access archived brand image content. An accounting database tracks costs associated with brand image reconfiguration.

This application claims the benefit of U.S. provisional application Ser. No. 60/554,404, filed Mar. 17, 2004, the entire content of which is incorporated herein by reference.

### FIELD

This invention relates to a method of operating a vehicle so as to permit its use by multiple operators and/or for multiple purposes.

### BACKGROUND

Time share aircraft rental business models have emerged in the business aircraft market as a means to provide reduced access cost for frequent purchasers of business aircraft services. These services are typically provided by third party owner-operator companies that rent access to their aircraft and infrastructure to frequent purchasers. This business model provides reduced cost of ownership for renters and improves asset utilization, e.g., utilization of aircraft, facilities, and personnel.

This service is typically provided using aircraft with no specific or unique brand image markings. In addition, the renting customer base typically does not want the aircraft branded with the owner-operator brand image, which informs observers that the aircraft is rented, nor with the renting customer's corporate brand image, primarily for security reasons. The lack of unique image branding requirements for the business aircraft market supports the time share business model for this market segment.

Commercial vehicles, such as cargo and passenger aircraft, are typically branded with the operator's unique brand image. The image branding elements are one of the primary means that operators use to promote and differentiate their service offerings from those of competitors. The technologies currently used to cast the desired image branding elements to a vehicle, both internal and external, are static and generally require significant cost and effort to change or customize.

For example, these technologies include the re-coating of interior brand image marking materials and the repainting of exterior surfaces. These inflexible brand image technology limitations force the industry to deploy a business model where expensive assets, e.g., aircraft costing $70-300 million, are purchased by a single operator, branded with the unique design elements of the purchasing operator, and placed in the exclusive service of the purchasing operator.

### SUMMARY

The invention is directed to a system and method for commercial vehicle operation using reconfigurable brand image technology to support dynamic rebranding. The use of reconfigurable brand image technology permits a commercial vehicle, such as an aircraft, to be used by multiple operators, for multiple purposes, or both.

For example, an aircraft may initially bear a first brand image, such as a company name, logo, or the like, associated with a first operator. The brand image is then selectively reconfigured, however, so that the aircraft bears a second brand image, which may be associated with a second operator. The ability to dynamically reconfigure the brand image supports shared use of an aircraft or other vehicle by multiple operators, while permitting the individual operators to present their respective brand identities to customers.

Reconfiguration may be facilitated by a networked, computer-implemented system that enables multiple rebranding clients to access remote databases storing scheduling information, branding information, and accounting information. Rebranding client devices may access a scheduling database to determine when a particular vehicle is scheduled for an operation segment, and whether an operator change will take place, requiring brand image reconfiguration.

The branding database may permit the rebranding client to access archived branding imagery for used in brand image reconfiguration. An accounting server may track costs and charges associated with the brand image reconfiguration process. The rebranding client devices may be located at multiple air terminals at which the aircraft lands for pickup, delivery or service.

In one aspect, the invention provides a method comprising establishing a first brand image for a vehicle, operating the vehicle with the first brand image for a first operating segment, establishing a second brand image for the vehicle within 48 hours of completion of the first operating segment, wherein the second brand image is different from the first brand image, operating the vehicle with the second brand image for a second operating segment, establishing a third brand image for the vehicle within 48 hours of the second operating segment, wherein the third brand image is different from the second brand image, and operating the vehicle with the third brand image for a third operating segment.

In another aspect, the invention provides a system comprising a scheduling database storing information relating to operators associated with different operation segments of a vehicle, a content database storing brand image content associated with the operators, a brand output device that produces brand image media using the brand image content, and a rebranding client that accesses the scheduling database to identify one of the operators associated with one of the operation segments, accesses the content database to retrieve brand image content associated with the identified operator, and controls the brand output device to generate brand image media bearing the retrieved brand image content for the identified operator.

In an additional aspect, the invention provides a computer-readable medium comprising instructions to cause a processor to access a scheduling database to identify one of a plurality of operators associated with one of a plurality of operation segments of a vehicle, access a content database to retrieve brand image content associated with the identified operator, and control a brand output device to generate brand image media bearing the retrieved brand image content for the identified operator.

The invention may provide, in various embodiments, one or more advantages. For example, in some embodiments, the invention may enable a commercial vehicle business process model that permits the use of a commercial vehicle by multiple operators, e.g., on a time sharing basis, with different brand images being displayed by the commercial vehicle when the different operators have control of the vehicle. Alternatively, the invention may permit use of a commercial vehicle, which can be branded for multiple purposes such as travel along different routes or delivery of different services by a given operator. In some cases, the invention may support the use of a commercial vehicle for both multiple operators and multiple purposes as defined by the branding that changes on the vehicle depending on the operator and the purpose of use.

As further advantages, in some embodiments, vehicle manufacture can be simplified through reduced use of permanent brand image elements on vehicle interiors and through reduction or elimination of the need for brand image livery painting of the vehicle exterior. Operators can make use of the reconfigurable brand image capability to generate brand awareness through unique design elements and/or to generate revenue through the sale of promotional content and space, e.g., for advertising purposes.

Furthermore, the invention may make possible the formation of operator alliances to leverage buying power with original equipment manufacturers (OEMs) for common vehicle configurations. Such alliances can also reduce ownership costs through the sharing of assets, such as vehicles, facilities, labor, and infrastructure, among alliance participants. This can improve asset utilization, while retaining the ability of alliance participants to maintain their unique brand images and messages.

In some embodiments, the invention also can facilitate the evolution of financing options to accommodate more flexible multi-owner asset acquisitions, as well as insurance options to accommodate multi-owner asset utilization. Opportunities can develop for new industry participants to provide asset ownership and management for multi-operator environments, brand image and/or promotional design element optimization and distribution coordination, and new unique risk sharing relationships.

For the airline industry, in particular, the invention potentially enables a reduction in operator asset ownership costs through more flexible purchase and disposal options. Excess airline industry capacity can be relieved through asset sharing arrangements, and airline industry gate capacity limitations can be relieved through facility/infrastructure sharing arrangements.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWING

FIG. 1 is a flow diagram illustrating an embodiment of a method for vehicle operation using reconfigurable brand images in accordance with the invention.

FIG. 2 is a block diagram illustrating an embodiment of a system for implementing the method of FIG. 1.

FIG. 3 is a block diagram illustrating a network implementation of a system for implementing the method of FIG. 1.

FIG. 4A is a flow diagram illustrating a conventional mode of operation of a commercial vehicle.

FIG. 4B is a flow diagram illustrating a mode of operation of a commercial vehicle in accordance with an embodiment of the invention.

FIG. 5 is a schematic diagram of an aircraft illustrating establishment of brand images.

FIG. 6 is a block diagram illustrating a network implementation of a system for implementing the method of FIG. 1 in greater detail.

FIG. 7 is a flow diagram illustrating operation of the system of FIG. 6.

### DETAILED DESCRIPTION

The invention is directed to a system and method for commercial vehicle operation using reconfigurable brand imagery that permits dynamic branding of commercial vehicles. The invention also contemplates computer-readable media comprising instructions to cause one or more processors to perform various aspects of the methods described herein. In addition, the invention contemplates a networked computer system that facilitates rebranding at one or more distributed rebranding facilities.

As used in this disclosure, the term “vehicle” generally refers to a transportation vehicle or a transportation vehicle support service element, such as an aircraft gate, ground support equipment, or ground support vehicle. The term “reconfigurable brand image technology” generally refers to a technology that is capable of providing a plurality of interchangeable brand images that can be changed from one to another on a time scale that is shorter than about 48 hours, preferably, less than about 24 hours, more preferably, less than about 12 hours, even more preferably, less than about 6 hours, yet more preferably, less than about 3 hours, and most preferably, less than about 1 hour.

The term “brand image” generally refers to a textual, graphic or auditory sensory element, or set of such elements, such as colors, patterns, designs, words, letters, symbols, textures, sounds, fragrances, or combinations thereof, that are capable of sensory perception by human beings. The brand image may identify the operator of a vehicle, and may vary according to the operator or the purpose for which the vehicle is used by the operator, e.g., passenger service versus cargo service. Also, in some cases, a brand image may include promotional content such as advertising, including operator advertising or third party advertising carried pursuant to an advertising relationship between the operator and the third party.

The term “establish,” in regard to establishment of a brand image of a vehicle, generally refers to application of one or more elements of a brand image to the interior, exterior, or both, of a vehicle in a manner that permits their sensory perception by human beings. Establishment may further involve removal or reconfiguration of an existing brand image prior to application of a brand image. The term “operating,” i.e., operating a vehicle, generally refers to utilization of the vehicle, e.g., in either a stationary or mobile manner.

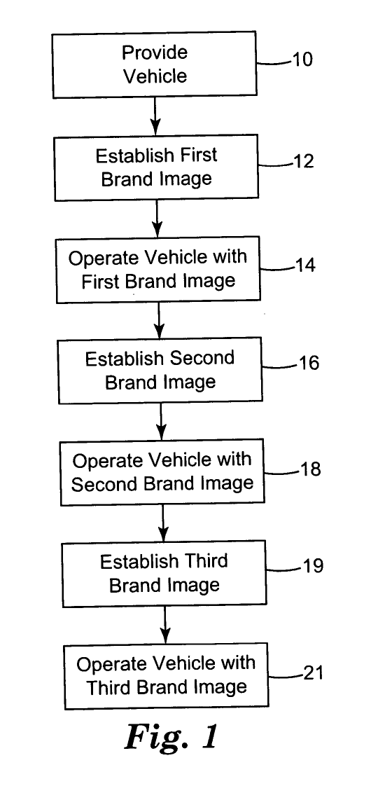

FIG. 1 is a flow diagram illustrating an embodiment of a method for vehicle operation using reconfigurable brand images in accordance with the invention. As shown in FIG. 1, in an exemplary embodiment, the method comprises providing a vehicle (10) with at least one reconfigurable brand image technology. The vehicle can be any transportation vehicle or transportation vehicle support service element, such as an aircraft gate, ground support equipment, or ground support vehicle. Preferably, the vehicle is a commercial vehicle, such as a commercial truck, train, automobile, boat, ship, or aircraft, or any of their support service elements. More preferably, the vehicle is an aircraft or aircraft support service element. The aircraft may be a commercial cargo or passenger aircraft.

The reconfigurable brand image technology can be any known or hereafter-developed technology that is capable of providing a plurality of interchangeable brand images that can be changed from one to another on a time scale that is shorter than about 48 hours, preferably, less than about 24 hours, more preferably, less than about 12 hours, even more preferably, less than about 6 hours, yet more preferably, less than about 3 hours, and most preferably, less than about 1 hour.

Examples of reconfigurable brand image technologies include film technologies, coating technologies, display technologies, projection systems or a combination of such technologies. Other examples of reconfigurable brand image technologies include attachment of a graphic medium to the vehicle using mechanical fasteners, application of the graphic medium to the vehicle using magnetic attraction between the surface of the vehicle and a backside of the graphic medium, attachment of the graphic medium to the vehicle using static electricity, and attachment of the graphic medium to the vehicle using surface printing technologies. The reconfigurable image technologies may be integral with the vehicle, placed within the interior of the vehicle, or placed on the exterior of the vehicle.

In the case of film technologies, for example, a polymeric film may be printed to carry brand image content and then placed on the interior or exterior of a vehicle, such as an aircraft. The film may be adhesively attached to a surface of the vehicle. For example, the film may carry an adhesive backing layer. In some embodiments, the adhesive backing layer may be activated or cured by application of thermal energy or radiation. To permit establishment of a brand image, and the existing brand image may be peeled away from a surface of the vehicle. In some embodiments, the peel-away process may be aided by application of thermal energy or radiation. The peel and application steps may be repeated for each new brand image that is desired for a given vehicle.

In the case of coating technologies, a paint coating may be spray- or roll-coated over a pre-existing coating, e.g., using templates prepared by a printing device. Alternatively, a pre-existing coating may be entirely or partially removed using solvents or other techniques, prior to application of a new coating bearing a different brand image. For example, a paint coating may be applied to the aluminum fuselage or tail of an aircraft to present a first brand image, and then be removed and/or overcoated by a paint coating that presents a second brand image. Alternatively, a device may be designed to directly print, or otherwise deposit, ink, paint or other coatings onto the vehicle surface.

Display and projection technologies also may be used to quickly change the brand image of a vehicle. For example, a display may be mounted on or within a vehicle, or both, and present a brand image. The display may be an electronic or chemical display. Alternatively, a light projector may project an image onto a surface of the vehicle. The projector may be mounted on or within the vehicle, e.g., on a wing of an aircraft for projection onto the fuselage, or mounted on equipment positioned adjacent the vehicle when the vehicle is not in use.

For example, a projector may project a brand image onto an aircraft parked at a gate. When the aircraft leaves the gate, the image is no longer projected on the aircraft. By providing the projection at the gate, however, the image is viewed at the time the aircraft is most visible to persons on the ground. In each case, a different set of image data may be selected when the operator of a vehicle changes, so that a first brand image can be changed to a second brand image via a display or projector that presents imagery based on the image data.

For mechanical attachment of a graphic medium, a variety of mechanical fasteners, such as screws, nails, staples, brackets, or the like, may be used. In the case of magnetic media, a brand image may be printed on a rigid or flexible magnetic plate and quickly applied to the surface of the vehicle, provided the vehicle and the plate magnetically attract one another. In other cases, static electricity may be used to promote attraction between an image-bearing substrate and the surface of the vehicle.

Upon establishment of a first brand image (12) on or within the vehicle, an operator operates the vehicle with the first brand image (14). As discussed above, a re-configurable brand image technology is utilized to establish the first brand image for the vehicle. The brand image may comprise a set of textual, graphic or sensory elements, such as colors, patterns, designs, words, letters, symbols, textures, sounds, fragrances, or combinations thereof, that are capable of sensory perception by human beings.

Preferably, the first brand image comprises a business organization name and/or symbol or logo. For an aircraft, the first brand image may include an airline name and/or logo. Alternatively, or additionally, the first brand image, may include promotional content such as, for example, advertisements or brochures pertaining to a product or service, or informational content such as, for example, instructions, directions, or news. The first brand image is established by applying the elements of the brand image to the interior and/or the exterior of the vehicle in any manner that makes possible their sensory perception by human beings.

Operation of the vehicle (14) involves utilizing the vehicle in either a stationary or mobile manner. The period during which a particular operator uses the vehicle may be referred to as an operation segment. The operation segment may correspond to any operation of the vehicle, including stationary or mobile use, as discussed above. In some embodiments, an operation segment may correspond to a travel segment, such as a one-way leg or two-way trip between one or more origination points and one or more destination points. For example, an aircraft can be flown on a flight segment from one city to another, or an aircraft support service element can be used in a stationary or mobile manner by a particular operator. In each case, the period during which an operator uses the vehicle may be referred to as an operation segment.

In various embodiments, a vehicle may be used on a shared basis for several different operation segments, with different operators, over the course of several hours, days or weeks. In these cases, it may be desirable to apply different brand images to the vehicle for the operation segments. For example, a first operator may operate the vehicle to carry business travelers to a particular destination in the morning on a given day. On that same day, a second operator may use the vehicle to carry business travelers to another destination. The first and second operators will find it desirable to use the vehicle on a shared basis, yet preserve their own branding during their own operation segments.

As another example, a given operator may use the vehicle for different purposes, each of which may be considered a different operation segment, making different branding desirable. For example, the same operator may operate the vehicle on a first operation segment to carry business travelers, and operate the vehicle on a second operation segment to support cargo services such as delivery of packages, supplies, food stocks, or the like. In this case, although the same operator uses the vehicle, it may be desirable to rebrand the vehicle according to the particular services provided, e.g., passenger travel vs. package delivery.

Upon completion of a first operation segment (14), the method involves establishing a second brand image (16), as described above. In particular, a re-configurable brand image technology is utilized to establish the second brand image for the vehicle. The second brand image is different from the first brand image in one or more characteristics. For example, the second brand image preferably comprises a business organization name and/or symbol that is different from the name and/or symbol of the first brand image. In this manner, the second brand image differentiates the operator or service associated with the second operation segment from the operator or service associated with the first operation segment.

Following establishment of the second brand image (16), an operator then operates the vehicle with the second brand image (18). In this manner, the operator is able to project its own brand image during the second operation segment. As further shown in FIG. 1, a third brand image may be established for the vehicle (19), and an operator may operate the vehicle with the third brand image for a third operation segment (21). The operator for the first, second and third segments may be different operators, or the same operator using the vehicle in different operation segments for different purposes. In some cases, the third operator may be the same as the first operator, such that the establishment of the third brand image is a reversion to the first brand image. In other cases, the third brand image is different from both the first and second brand images.

The process outlined in FIG. 1 may be repeated on a continuous basis as the vehicle transitions between different operators or different purposes. In many instances, the time between operation segments, and hence the time between establishment of different brand images may be relatively short. For example, the time between operation segments may be on the order of 48 hours, 24 hours, 12 hours, 6 hours, 3 hours, or 1 hour. Accordingly, the availability of rapid re-configurable brand image technology may be desirable in many instances. In some embodiments, such as embodiments that use display or projection technology to facilitate the branding, the branding may be changed instantaneously in response to computer generated commands.

The methods described herein can further comprise one or more additional steps. For example, one or more steps of the methods can be repeated one or more times, if desired, e.g., to establish a plurality of brand images for a plurality of operation segments. In addition, establishment of brand images may be performed dynamically as the need for a particular brand image arises. Alternatively, in some embodiments, brand image media, or materials used in establishment of brand images, may be prepared in advance and held in inventory until needed. In addition, the establishment of brand images may be carried out at geographically distributed vehicle terminals, each of which is equipped with facilities for implementing reconfigurable brand image technology. As an alternative, all establishment of brand images may be carried out at one or more central terminals having special capabilities for implementing reconfigurable brand image technology.

Various aspects of the method of the invention can be implemented or facilitated, for example, by software running on a computer system. Such a computer system can comprise a single computer or a plurality of computers connected in a network. The network can be either wired or wireless, including conventional ground-based wireless networks as well as space-based wireless networks that rely upon satellite links. The source of information can be an electronic real-time feed or an electronic archive that is stored on a ground-based or vehicle-based mass storage device (such as a hard drive or other non-volatile or volatile memory) or on a network server.

Thus, a system that is useful for carrying out the method of the invention may comprise (a) at least one source of brand image information and vehicle information, e.g., vehicle identification, maintenance, routing, and/or scheduling information; (b) at least one user interface containing links or other forms of access to at least a portion of the information, e.g., such that a user can administratively manage the information source, can select a particular vehicle and/or a particular brand image, or, alternatively, can be informed of a selection of either or both that has been designated based upon, for example, predetermined criteria or selection by another user; and (c) at least one vehicle interface, which can be the same as or different from the user interface, containing links or other forms of access to at least a portion of the information, e.g., so that the vehicle can receive information concerning its selection and/or concerning a selected brand image and so that the vehicle's re-configurable brand image technology can be activated, either by the system or separately, to establish the selected brand image. The system can be used to implement some or all of the method steps. The system can further comprise one or more elements of conventional computers or computer networks.

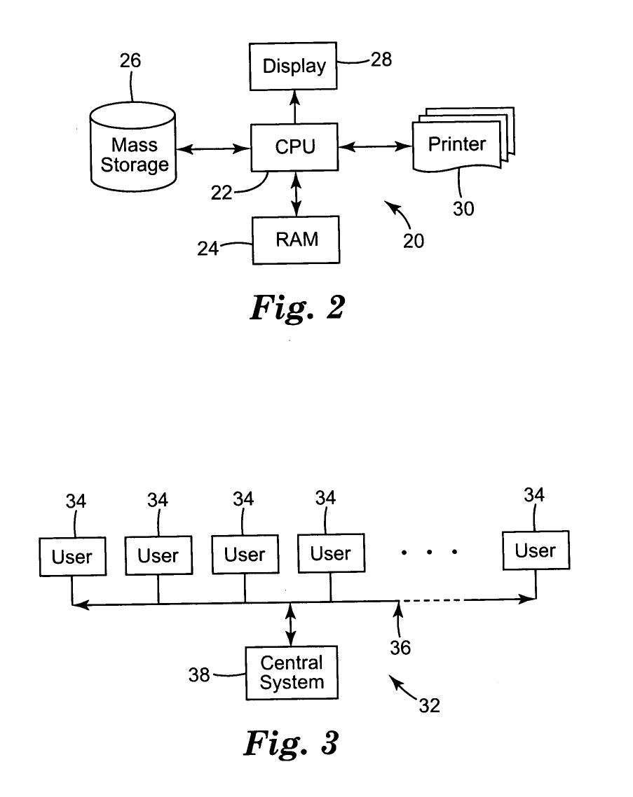

FIG. 2 is a block diagram illustrating an embodiment of a computer system 20 for implementing various aspects of the method of FIG. 1. In the example of FIG. 2, system 20 includes a central processing unit (CPU) 22, a random access memory (RAM) 24, a mass storage device 26, such as a magnetic or optical hard drive, a CD-ROM drive, a magnetic diskette drive, a solid state media drive, or the like, a display 28, such as a cathode ray tube (CRT) monitor), light emitting diode (LED) display, liquid crystal display (LCD), or plasma display, and optionally a printer 30, such as a dot matrix printer, a laser printer, or an ink jet printer, associated such that the CPU 22 can read and write to the RAM 24, and the CPU 22 can retrieve images from mass storage device 26 for presentation on display 28 or presentation via the output of the printer 30.

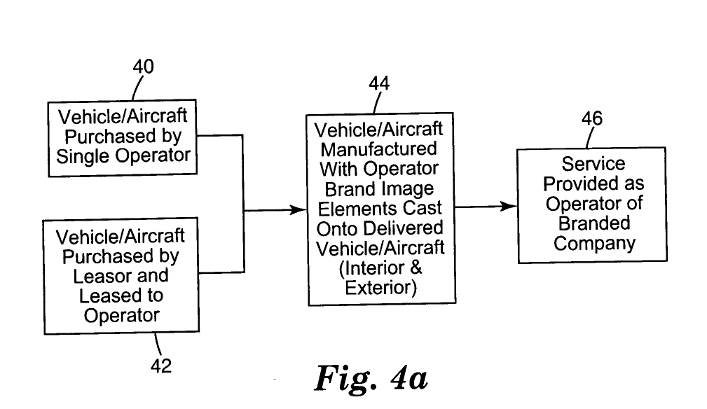

FIG. 3 is a block diagram illustrating a network implementation of a system for implementing the method of FIG. 1. In the example of FIG. 3, system 32 includes a plurality of user/vehicle systems 34 connected via a network 36 to a central system 38. The central system 38 and each user/vehicle system 34 can be generally of the type described as computer system 20 of FIG. 3. The number of user/vehicle systems 34 connecting to the central system 38 via network 36 can be fixed or can vary from time to time. The method of connection can be direct or indirect, for example, by modem, over a dedicated cable or line, over an intervening network, such as the Internet, through a wireless connection, or by any other appropriate system.

In some embodiments, central system 38 may take the form of one or more servers, in combination with associated database and file servers, that provides scheduling information, brand image content information, or both to user/vehicle systems 34. In addition, central system 38 may include an accounting database that manages cost information associated with establishment of brand images for particular operators, vehicles or operation segments. In other embodiments, central system 38 may be realized by a set of separate servers, databases and file servers dedicated to particular functions, such as scheduling, brand image content and accounting. In some cases, such servers may be implemented in part by web servers that provide user/vehicle systems 34 with access to web pages or other resources.

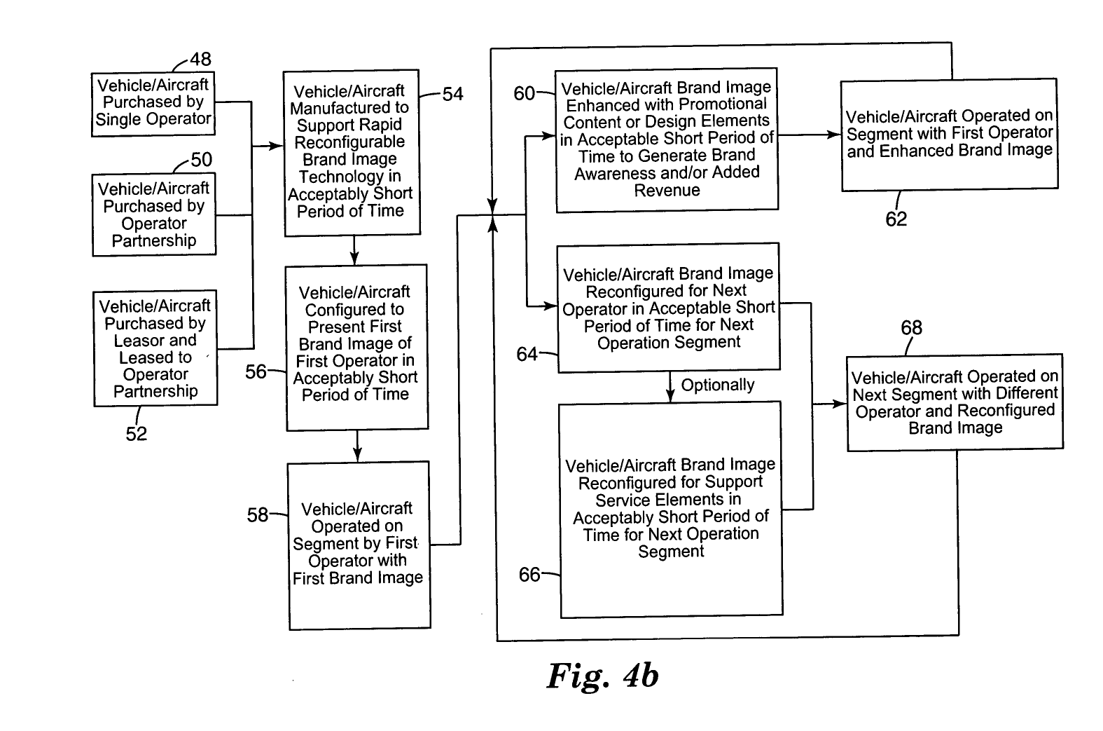

FIG. 4A is a flow diagram illustrating a conventional mode of operation of a commercial vehicle. As shown in FIG. 4A, conventionally, a vehicle such as an aircraft is purchased by a single operator (40) or a vehicle is purchased by a lessor and leased to an operator, such ass an airline (42). In these cases, the vehicle is manufactured with operator brand image elements (44) that are cast onto, i.e., applied to, the vehicle interior, exterior, or both. The intention is that the brand image elements remain generally fixed from operation segment to operation segment, which is ordinarily appropriate given that the vehicle is operated by a single operator. With fixed branding, the operator or company identified by the brand provides a service using the vehicle (46).

FIG. 4B is a flow diagram illustrating a mode of operation of a commercial vehicle in accordance with an embodiment of the invention. The mode of operation represented in FIG. 4B contemplates operation of a vehicle on a shared basis among multiple operators or, alternatively, operation of a vehicle for multiple purposes. In each case, establishment of different brand images for different operation segments is generally desirable. Hence, unlike the conventional business model shown in FIG. 4A, which rely on static branding, a method according to the example of FIG. 4B enables timeshare business models with dynamic branding that permits different operators to retain brand uniqueness.

As shown in FIG. 4B, a vehicle, such as an aircraft, is purchased by a single operator (48), an operator partnership (50), or a lessor that leases the vehicle to an operator or operator partnership (52). The vehicle is manufactured to support one or more rapid reconfigurable brand image technologies (54). For example, the vehicle may support branding with reconfigurable brand image technologies such as films, coatings, displays, projectors, or the like, as discussed above.

The brand image of the vehicle is initially configured to present the brand image of the operator associated with a first operation segment of the vehicle (56). The establishment of the initial brand image preferably is performed in an acceptably short period of time, such as in less than 48 hours. On a first operation segment, the vehicle is operated using the first brand image (58).

For a later operation segment, the first brand image may be enhanced by addition of promotional content or design elements to generate brand awareness and/or additional revenue (60). The promotional content may be operator or third party advertising content. In this case, the initial brand image elements of the first brand image may be supplemented by additional image elements, which may pertain to the operator or a third party that has purchased advertising space on the vehicle. The vehicle is then operated by the first operator on the next operation segment with the enhanced brand image (62).

Alternatively, or additionally, the vehicle brand image elements can be reconfigured to change the brand image from a first brand image to a second brand image (64). The second brand image may correspond to a different operator associated with the next operation segment, or a different purpose or service associated with the next operation segment. The reconfiguration preferably is performed in an acceptably short period of time, as described herein, to avoid excessive delays in the commencement of the next operation segment.

Optionally, an existing brand image may be reconfigured for support service elements (66), such as ground support equipment or vehicles, in the case of aircraft. Other examples of support service elements that can be rebranded include gates, jetways, and uniforms for pilots, flight attendants, gate personnel, ground personnel, food service providers, and other staff. The vehicle then is operated by the operator on the next operation segment with the reconfigured brand image (68).

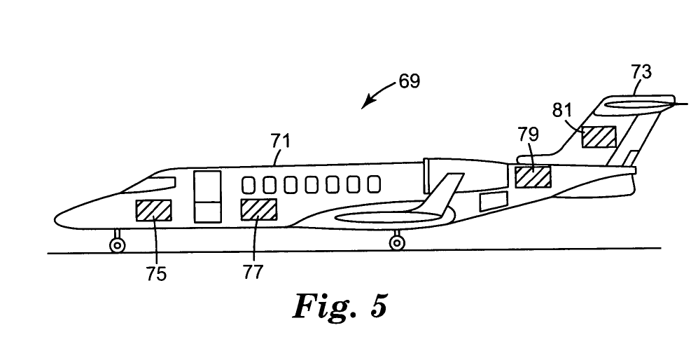

FIG. 5 is a schematic diagram of an aircraft 69 illustrating establishment of brand images. As shown in FIG. 5, brand images may be placed at various locations on aircraft 69, e.g., on fuselage 71 or tail 73. In the example of FIG. 5, brand images may be positioned at locations 75, 77, 79, 81. In some embodiments, a brand image may span a substantial portion of the entire fuselage 71 or tail 73. As discussed previously, the brand images preferably are formed by a reconfigurable brand image technology that permits rapid reconfiguration of brand images.

A preferred reconfigurable brand image technology involves the application of a polymeric film carrying graphics to the fuselage 71 or tail 73 of aircraft 69. An example of a suitable film technology is the commercial graphics film commercially available from 3M Company of St. Paul, Minn., as Scotchprint™ Graphics. A variety of inkjet printers are available to print high quality graphics on a variety of films with different adhesives, permitting both interior and exterior use. Exemplary films include fluoropolymer, polyurethane, polyester, vinyl, and multi-layer films. Exemplary adhesives include acrylic, silicone, rubber, epoxy, and other pressure sensitive and cured adhesives.

The film can be printed on demand to quickly form desired graphics for application to the surface of a vehicle. Conversely, the film can be readily removed from the surface of the vehicle to make room for a new graphic. Accordingly, commercial graphics films, adhesives and printing systems provide a suitable option for realization of a reconfigurable brand image technology, as described herein. Other suitable options include coatings, displays, and projection systems.

Although FIG. 5 depicts application of reconfigurable branding technology to an aircraft 69, other vehicles such as trucks, trains, automobiles, boats and the like may likewise take advantage of dynamic branding. In turn, dynamic branding may facilitate shared use of such vehicles while preserving the brand identity of individual operators or particular services offered by operators.

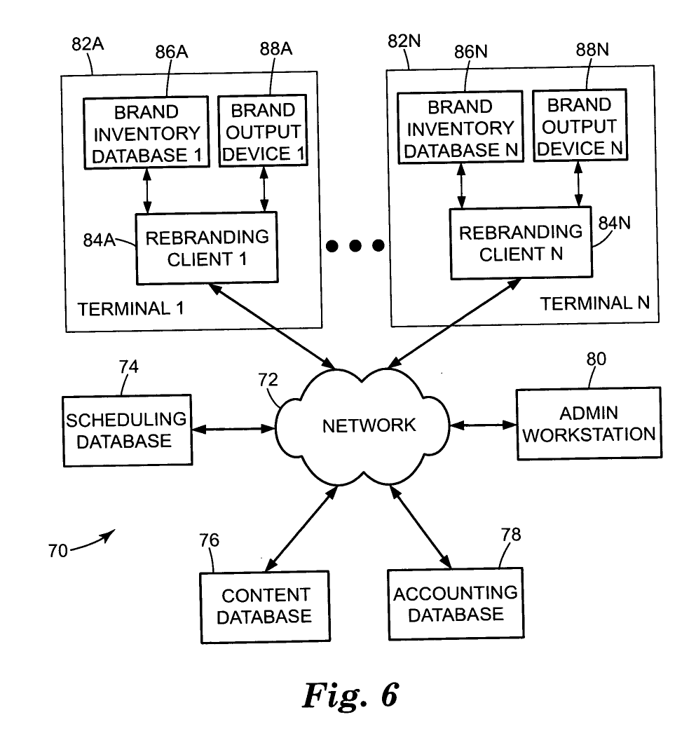

FIG. 6 is a block diagram illustrating a network implementation of a system 70 for implementing the method of FIG. 1 in greater detail. In some embodiments, the components of system 70 in FIG. 6 may form part of system 32 of FIG. 3. As shown in FIG. 6, system 70 includes a network 72 that interconnects a scheduling database 74, content database 76, accounting database 78, administrative workstation 80, and rebranding facilities 82A-82N (hereinafter rebranding facility 82). Network 72 may be the Internet or a private wide area network.

Although two rebranding facilities 82 are shown in FIG. 6, tens, hundreds or even thousands of rebranding facilities may be geographically distributed to provide rebranding services to vehicles. In the example of FIG. 6, each rebranding facility 82 includes a respective rebranding client device 84, a brand inventory database 86 and a brand output device 88. Rebranding facilities 82 interact with a scheduling database 74, content database 76, and accounting database 78 via network 72 to reconfigure brand images for vehicles served by the rebranding facilities.

A rebranding facility 82 may be located at a terminal for departure or arrival of vehicles. In the case of an aircraft, the terminal may be an airport or other air terminal. The terminal may be an ordinary terminal served by the vehicle, or a special terminal dedicated to reconfiguration of brand images between operation segments. Rebranding client 84 may be a client computer coupled to network 72. In some embodiments, rebranding client 84 may include web browser functionality to access web pages provided by scheduling database 74, content database 76, or accounting database 78. In particular, information provided by scheduling database 74, content database 76, or accounting database 78 may be accessible via hypertext links presented to a user via a web browser provided by rebranding client 84.

Rebranding client 84 controls brand output device 88, e.g., via a serial or network interface, to produce brand image media for establishment on or within a vehicle. Brand output device 88 may be a printer that prints film media, such as commercial graphics film. Alternatively, brand output device 88 may print template media for use in coating an exterior or interior of the vehicle, e.g., by spray- or roll-coating of paint or other coatings. As a further alternative, brand output device 88 may be a device designed to directly print, or otherwise deposit, inks, paints or other coatings on the surface of the vehicle.

As a further alternative, brand output device 88 may be a raster image processor that generates image data to drive a display device or a projector for presentation of a brand image on the vehicle on a persistent basis, or presentation of the brand image temporarily at a departure/arrival area of the vehicle. In each case, brand output device 88 generates a reconfigured brand image for application to the vehicle.

In some instances, it may be necessary to remove a previously established brand image from the vehicle prior to application of the reconfigured brand image media. In other embodiments, the reconfigured brand image media may be applied over the existing brand image. Preferably, the removal of a pre-existing brand image and the application of the reconfigured brand image requires a relatively short period of time, such as less than about 48 hours, preferably, less than about 24 hours, more preferably, less than about 12 hours, even more preferably, less than about 6 hours, yet more preferably, less than about 3 hours, and most preferably, less than about 1 hour.

Brand inventory database 86 provides information concerning available brand image media. For example, brand inventory database 86 may indicate whether an inventory of film media or coating template media has already been prepared for a particular brand image. Alternatively, brand inventory database 86 may indicate whether a set of raster image data is already archived for the particular brand image. In either case, the brand image media in inventory can be used to establish the reconfigured brand image. Accordingly, it is not necessary for rebranding client 84 to control brand output device to produce brand image media. For this reason, rebranding client 84 may be configured to consult brand inventory database 86 before attempting to produce new brand image media via brand output device 88.

In operation, rebranding client 84 accesses scheduling database 74 to obtain scheduling information. The scheduling information may indicate the next operation segments, or the next several operation segments, for a given vehicle. In addition, the scheduling information may indicate the operator or type of operation or purpose associated with each operation segment. Although not shown in FIG. 6, scheduling database 74 may include a database archive, database server, web server, and any other network or computing components necessary to store and provide scheduling information for rebranding client 84. In some embodiments, scheduling database 74 delivers scheduling information to rebranding client 84 as one or more web pages containing the scheduling information.

If scheduling database 74 indicates a change in operator, or a change in purpose, for the next operation segment or future operation segment of interest, rebranding client 84 determines that a reconfiguration of brand image is necessary for the vehicle. In this case, if rebranding client 84 has not previously obtained brand image content for the identified operator or purpose, the rebranding client accesses content database 76 to obtain the desired brand image content.

Content database 76 provides a centralized repository of brand image content, and ensures that brand image content is centrally managed and updated for use by rebranding facilities 82. Although not shown in FIG. 6, content database 76 may include a database archive, database server, web server, and any other network or computing components necessary to store and provide brand image content to rebranding client 84. In some embodiments, even if rebranding client 84 has previously obtained brand image content for a particular operator or purpose, the rebranding client 84 may consult content database 76 to determine whether updated content is available.

Once rebranding client 84 obtains appropriate brand image content, or verifies that such content has already been obtained and is in an updated form, the rebranding client 84 proceeds to control brand output device 88 to produce the corresponding brand image for the vehicle. As mentioned previously, rebranding client 84 may first consult inventory database 86 to determined whether brand image media has already been prepared and is available.

Once the brand image has been established for the vehicle, rebranding client 84 may prepare accounting information detailing the cost or charges associated with the brand image reconfiguration, including labor and materials costs and the identity of the pertinent vehicle operator. Rebranding client 84 then sends the accounting information to accounting database 78, which records the information for the preparation of billing invoices to particular operators. Like scheduling database 74 and content database 76, accounting database 78 may include a database archive, database server, web server, and any other network or computing components necessary to store accounting information.

Administrative workstation 80 permits an administrator to load software updates and generally maintain any of scheduling database 74, content database 76, accounting database 78, and rebranding clients 84. In addition, an administrator may use administrative workstation to load new or update brand image content into content database 76. The administrator may manage scheduling information stored in scheduling database 74, and accounting information stored in accounting database 78, via administrative workstation 80. The administrator also may manage access privileges for individuals assigned to operate rebranding clients 84.

As discussed above, rebranding client 84 may be located within a vehicle terminal, e.g., adjacent an arrival/departure area, such as an aircraft gate and jetway. Alternatively, the rebranding client 84, brand output device 88 or both may be located remotely from the vehicle arrival/departure area, or the air terminal itself. For example, brand image media may be prepared and delivered to the vehicle. In other cases, rebranding facility 82 may be located in a workspace, such as a hangar, dedicated to repair, maintenance, or rebranding.

In some instances, a rebranding client 84, or a client device with access to information obtained by rebranding client, may be provided within a vehicle itself. A pilot, captain, driver or other vehicle operator staff member may observe the rebranding status, or even control the rebranding process. For example, in some embodiments, a person could manually override or delay a scheduled brand reconfiguration to handle an unscheduled operation segment. In this manner, the ability to dynamically reconfigure the brand image may be delegated to the person responsible for piloting the vehicle.

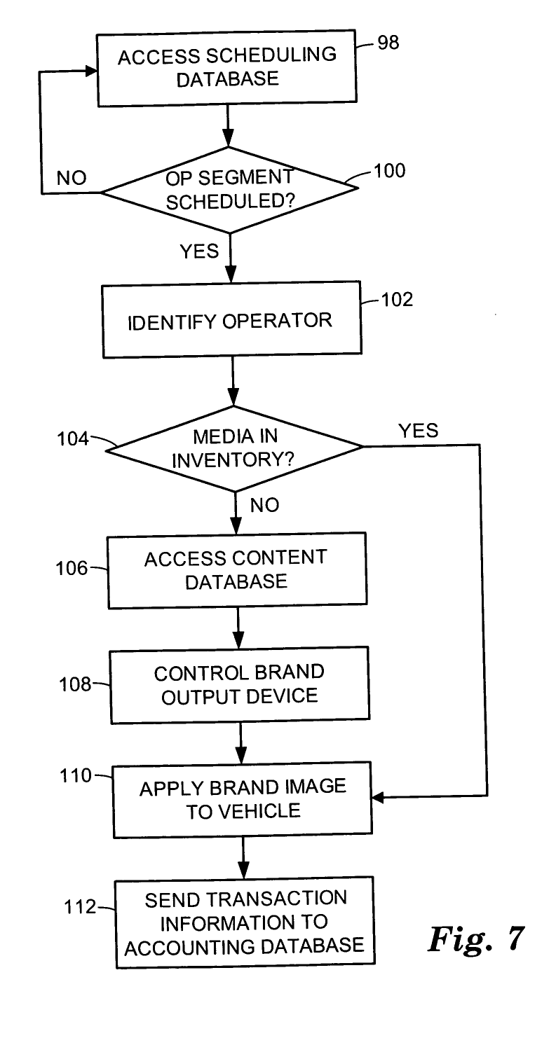

FIG. 7 is a flow diagram illustrating operation of system 70 of FIG. 6. As shown in FIG. 7, rebranding client 84 accesses scheduling database 74 (98) via network 72 to obtain scheduling information relating to an operation segment of a vehicle. If an operation segment is scheduled (100), rebranding client 84 identifies the operator (102) associated with the operation segment, i.e., by reference to the scheduling information.

Alternatively, or additionally, rebranding client 84 may determine a purpose of the operation segment. As mentioned previously, a change in operational purpose may require rebranding even though the same operator may be handling the next operation segment. An example of a change in operational purpose is the use of the vehicle for passenger service in one operational segment, followed by use of the vehicle for package delivery in another operational segment. In addition, in some embodiments, a vehicle may be used to deliver a different class or quality of service, such as first class service versus standard service. In each of these cases, reconfiguration or enhancement of a brand image may be desirable.

Rebranding client 84 next determines whether brand image media for the particular operator (or purpose) is available in inventory (104) by reference to brand inventory database 86. If so, rebranding client 84 instructs personnel to apply the available brand image media to the vehicle to establish the brand image (110). If brand image media is not already available in inventory (104), rebranding client 84 controls brand output device 88 (108) to produce the required brand image media. The brand image media then is applied to the vehicle (110). Optionally, rebranding client 84 may consult brand content database 76 (106) to obtain brand image content or verify that brand image content is updated. Following establishment of the new brand image, rebranding client 84 sends transaction information relating to the rebranding costs to accounting database 78 (112).

Various aspects of the invention may be implemented by one or more computers or processors upon execution of software in the form of computer-readable instructions stored in memory. The invention is not limited to any particular computing platform, software architecture or operating system. However, the invention preferably is adapted to make use of state-of-the art ecommerce platforms as they presently exist and as they may emerge in the future. Computer-readable instructions may be stored in any of a variety of different storage media, including magnetic, electronic, or optical media, whether configured as random access memory (RAM), read-only memory (ROM), electronically-erasable programmable ROM (EEPROM), flash memory, magnetic tape, magnetic disks, optical tape, optical disks, or the like, or a combination thereof.

Various unforeseeable modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only, with the scope of the invention intended to be limited only by the claims set forth herein.

1. A method comprising:
establishing a first brand image for a vehicle;
operating the vehicle with the first brand image for a first operating segment;
establishing a second brand image for the vehicle within 48 hours of completion of the first operating segment, wherein the second brand image is different from the first brand image;
operating the vehicle with the second brand image for a second operating segment;
establishing a third brand image for the vehicle within 48 hours of completion of the second operating segment, wherein the third brand image is different from the second brand image; and
operating the vehicle with the third brand image for a third operating segment.

2. The method of claim 1, wherein the third brand image is substantially identical to the first brand image.

3. The method of claim 1, wherein the third brand image is different from the first brand image.

4. The method of claim 1, wherein the vehicle is a commercial vehicle.

5. The method of claim 1, wherein the vehicle is a commercial aircraft.

6. The method of claim 1, wherein the vehicle is an aircraft support vehicle.

7. The method of claim 1, wherein each of the brand images includes an operator name and logo.

8. The method of claim 1, wherein each of the brand images includes an airline name and logo.

9. The method of claim 1, wherein the first and second brand images represent different operators.

10. The method of claim 1, wherein one or more of the brand images includes a promotional image.

11. The method of claim 1, further comprising:
accessing a scheduling database to identify operators associated with the first, second and third operation segments; and
selecting the first, second and third brand images based on the identified operators.

12. The method of claim 11, further comprising controlling a brand output device to produce brand image media corresponding to the selected brand images.

13. The method of claim 11, further comprising:
accessing a content database to retrieve brand image content for the selected brand images; and
controlling a brand output device, using the retrieved brand image content, to produce brand image media corresponding to the selected brand images.

14. The method of claim 11, further comprising:
accessing a brand inventory database to determine whether brand image media corresponding to the selected brand images are available; and
when brand image media corresponding to one of the selected brand images is not available, controlling a brand output device to produce brand image media corresponding to the selected brand image.

15. The method of claim 1, further comprising sending transaction information to an accounting database, wherein the transaction information associates production of the brand image media with one of a plurality of different operators.

16. The method of claim 1, wherein establishing a second brand image for the vehicle includes establishing the second brand image within 24 hours of completion of the first operation segment, and establishing a third brand image for the vehicle includes establishing the third brand image within 24 hours of completion of the second operation segment.

17. The method of claim 1, wherein establishing a second brand image for the vehicle includes establishing the second brand image within 12 hours of completion of the first operation segment, and establishing a third brand image for the vehicle includes establishing the third brand image within 12 hours of completion of the second operation segment.

18. The method of claim 1, wherein establishing a second brand image for the vehicle includes establishing the second brand image within 6 hours of completion of the first operation segment, and establishing a third brand image for the vehicle includes establishing the third brand image within 6 hours of completion of the second operation segment.

19. The method of claim 1, wherein establishing a second brand image for the vehicle includes establishing the second brand image within 3 hours of completion of the first operation segment, and establishing a third brand image for the vehicle includes establishing the third brand image within 3 hours of completion of the second operation segment.

20. The method of claim 1, wherein establishing a second brand image for the vehicle includes establishing the second brand image within 1 hour of completion of the first operation segment, and establishing a third brand image for the vehicle includes establishing the third brand image within 1 hour of completion of the second operation segment.

21. The method of claim 1, wherein establishing a second brand image includes producing a graphic medium bearing the second brand image, removing from the vehicle a graphic medium bearing the first brand image, and applying to the vehicle the graphic medium bearing the second brand image.

22. The method of claim 21, wherein applying the graphic medium includes adhesively attaching the graphic medium to the vehicle.

23. The method of claim 21, wherein the graphic medium bearing the second brand image includes a substrate, an adhesive backing, and printed imagery.

24. The method of claim 21, wherein applying the graphic medium includes one of projecting the image, attaching the graphic medium to the vehicle using mechanical fasteners, applying the graphic medium to the vehicle using surface coatings, attaching the graphic medium to the vehicle using magnetism, attaching the graphic medium to the vehicle using static electricity, attaching the graphic medium to the vehicle using surface printing technologies, and presenting the graphic medium on the vehicle using display technology.

25. The method of claim 1, wherein each of the operation segments is a trip to be taken by the vehicle.

26. A system comprising:
a scheduling database storing information relating to operators associated with different operation segments of a vehicle;
a content database storing brand image content associated with the operators;
a brand output device that produces brand image media using the brand image content; and
a rebranding client that accesses the scheduling database to identify one of the operators associated with one of the operation segments, accesses the content database to retrieve brand image content associated with the identified operator, and controls the brand output device to generate brand image media bearing the retrieved brand image content for the identified operator.

27. The system of claim 26, further comprising:
a brand inventory database to determine whether brand image media bearing brand image content associated with the identified operator is available,
wherein the rebranding client controls the brand output device to generate brand image media bearing the brand image content associated with the identified operator when the brand inventory database indicates that brand image media bearing brand image content associated with the identified operator is not available.

28. The system of claim 26, wherein the scheduling database stores information relating to operators associated with first, second and third operation segments of the vehicle, wherein the second operation segment begins less than 48 hours after completion of the first operation segment, and the third operation segment begins less than 48 hours after completion of the second operation segment.

29. The system of claim 26, wherein the scheduling database stores information relating to operators associated with first, second and third operation segments of the vehicle, wherein the second operation segment begins less than 24 hours after completion of the first operation segment, and the third operation segment begins less than 24 hours after completion of the second operation segment.

30. The system of claim 26, wherein the scheduling database stores information relating to operators associated with first, second and third operation segments of the vehicle, wherein the second operation segment begins less than 6 hours after completion of the first operation segment, and the third operation segment begins less than 6 hours after completion of the second operation segment.

31. The system of claim 26, further comprising an accounting database storing transaction information that associates production of the brand image media with one of a plurality of different operators.

32. The system of claim 26, wherein the vehicle is a commercial vehicle.

33. The system of claim 26, wherein the vehicle is a commercial aircraft.

34. A computer-readable medium comprising instructions to cause a processor to access a scheduling database to identify one of a plurality of operators associated with one of a plurality of operation segments of a vehicle, access a content database to retrieve brand image content associated with the identified operator, and control a brand output device to generate brand image media bearing the retrieved brand image content for the identified operator.

35. The computer-readable medium of claim 34, further comprising instructions to cause the processor to determine, by access to a brand inventory database, whether brand image media bearing brand image content associated with the identified operator is available, and control the brand output device to generate brand image media bearing the brand image content associated with the identified operator when the brand inventory database indicates that brand image media bearing brand image content associated with the identified operator is not available.

36. The computer-readable medium of claim 34, further comprising instructions to cause the processor to identify operators associated with first, second and third operation segments of the vehicle, access the content database to retrieve brand image content associated with the identified operators, and control the brand output device to generate brand image media bearing the retrieved brand image content for the identified operators, wherein the second operation segment begins less than 48 hours after completion of the first operation segment, and the third operation segment begins less than 48 hours after completion of the second operation segment.

37. The computer-readable medium of claim 36, wherein the second operation segment begins less than 24 hours after completion of the first operation segment, and the third operation segment begins less than 24 hours after completion of the second operation segment.

38. The computer-readable medium of claim 36, wherein the second operation segment begins less than 6 hours after completion of the first operation segment, and the third operation segment begins less than 6 hours after completion of the second operation segment.

39. The computer-readable medium of claim 34, further comprising instructions to cause the processor to send transaction information to an accounting database, wherein the transaction information associates production of the brand image media with one of a plurality of different operators.

40. The computer-readable medium of claim 34, wherein the vehicle is a commercial vehicle.

41. The computer-readable medium of claim 34, wherein the vehicle is a commercial aircraft.
